(19) United States
(12) Patent Application Publication
(10) Pub. No.: US 2017/0146979 A1
(43) Pub. Date: May 25, 2017

(54) Configuring a Manufacturing Device

(71) Applicant: INTERNATIONAL BUSINESS MACHINES CORPORATION, ARMONK, NY (US)

(72) Inventors: Minkyong Kim, Scarsdale, NY (US); James R. Kozloski, New Fairfield, CT (US); Clifford A. Pickover, Yorktown Heights, NY (US); Maja Vukovic, New York, NY (US)

(21) Appl. No.: 14/945,471

(22) Filed: Nov. 19, 2015

(51) Int. Cl. G05B 19/408

(52) U.S. Cl. CPC G05B 19/4083; G05B 2219/37518; G05B 2219/40502

(57) ABSTRACT

A method, system, and/or computer program product configure a manufacturing device. One or more processors generate a first inflation expectation value (IEV), which incorporates a price of the first good, and a second IEV that incorporates a price of the second good. The processor(s) compare an accuracy of the first IEV to an accuracy of the second IEV in predicting a future inflation index. In response to the first IEV more accurately predicting the future inflation index than the second IEV, one or more component positioning devices configure future configurations of the manufacturing device based on an inflation expectation described in the first IEV.

### BACKGROUND

The present disclosure relates to the field of robotics, and specifically to the use of robots used in the field of manufacturing. Still more particularly, the present disclosure relates to configuring manufacturing devices according to predicted rates of inflation.

### SUMMARY

In an embodiment of the present invention, a method, system, and/or computer program product configures a manufacturing device. One or more processors generate a first inflation expectation value (IEV), which incorporates a price of the first good, and a second IEV that incorporates a price of the second good. The processor(s) compare an accuracy of the first IEV to an accuracy of the second IEV in predicting a future inflation index. In response to the first IEV more accurately predicting the future inflation index than the second IEV, one or more component positioning devices configure future configurations of the manufacturing device based on an inflation expectation described in the first IEV.

In an embodiment of the present invention, a method, system, and/or computer program product configures a manufacturing device that is selectively configurable to produce a first good and a second good. One or more processors generate a first inflation expectation value (IEV), which utilizes a price of the first good, and a second IEV that utilizes a price of the second good. The processor(s) compare an accuracy of the first IEV to an accuracy of the second IEV in predicting an increase in a future inflation index. In response to the first IEV more accurately predicting the increase in the future inflation index than the second IEV, one or more component positioning devices configure the manufacturing device to produce the first good.

### BRIEF DESCRIPTION OF THE DRAWINGS

FIG. 1 depicts an exemplary system and network in which the present disclosure may be implemented;

FIG. 2 is a block diagram of an exemplary robotic manufacturing device that is reconfigured in accordance with one or more embodiments of the present invention;

FIG. 3 illustrates a high level overview of a novel process for generating an inflation expectation value (IEV);

FIG. 4 depicts various sources of data used to generate an IEV;

FIG. 5 is a high level flow chart of one or more steps performed by one or more processors and/or other hardware devices to configure a manufacturing device's production level in accordance with one or more embodiments of the present invention;

FIG. 6 is a high level flow chart of one or more steps performed by one or more processors and/or other hardware devices to configure a manufacturing device to produce a certain good based on a most accurate inflation expectation value in accordance with one or more embodiments of the present invention;

FIG. 7 depicts a cloud computing node according to an embodiment of the present disclosure;

FIG. 8 depicts a cloud computing environment according to an embodiment of the present disclosure; and

FIG. 9 depicts abstraction model layers according to an embodiment of the present disclosure.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

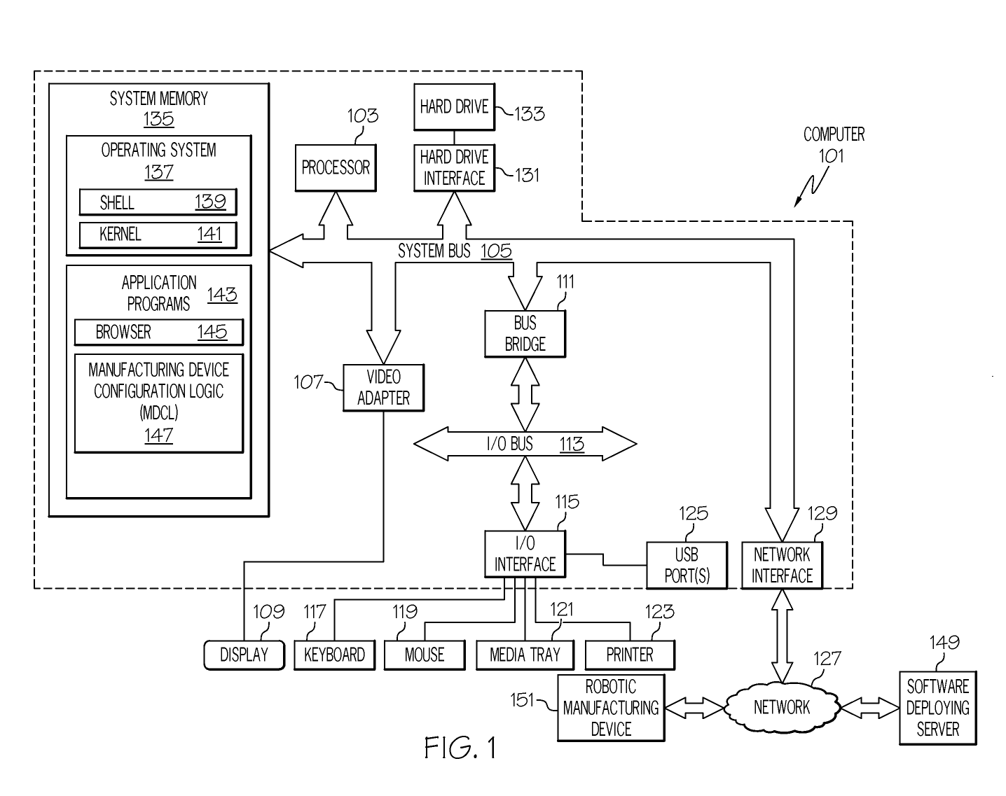

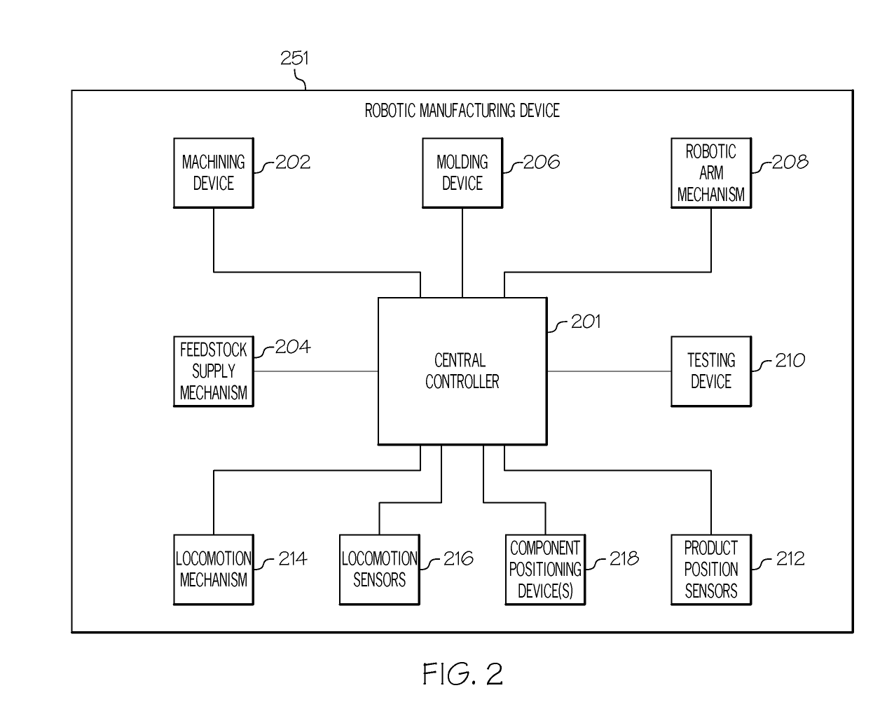

With reference now to the figures, and in particular to FIG. 1, there is depicted a block diagram of an exemplary system and network that may be utilized by and in the implementation of the present invention. Note that some or all of the exemplary architecture, including both depicted hardware and software, shown for and within computer 101 may be utilized by software deploying server 149 depicted in FIG. 1 and/or the central controller 201 depicted in FIG. 2.

Exemplary computer 101 includes a processor 103 that is coupled to a system bus 105. Processor 103 may utilize one or more processors, each of which has one or more processor cores. A video adapter 107, which drives/supports a display 109, is also coupled to system bus 105. System bus 105 is coupled via a bus bridge 111 to an input/output (I/O) bus 113. An I/O interface 115 is coupled to I/O bus 113. I/O interface 115 affords communication with various I/O devices, including a keyboard 117, a mouse 119, a media tray 121 (which may include storage devices such as CD-ROM drives, multi-media interfaces, etc.), a printer 123, and external USB port(s) 125. While the format of the ports connected to I/O interface 115 may be any known to those skilled in the art of computer architecture, in one embodiment some or all of these ports are universal serial bus (USB) ports.

As depicted, computer 101 is able to communicate with a software deploying server 149 and/or a robotic manufacturing device 151 via a network 127 using a network interface 129. Network interface 129 is a hardware network interface, such as a network interface card (NIC), etc. Network 127 may be an external network such as the Internet, or an internal network such as an Ethernet or a virtual private network (VPN).

A hard drive interface 131 is also coupled to system bus 105. Hard drive interface 131 interfaces with a hard drive 133. In one embodiment, hard drive 133 populates a system memory 135, which is also coupled to system bus 105. System memory is defined as a lowest level of volatile memory in computer 101. This volatile memory includes additional higher levels of volatile memory (not shown), including, but not limited to, cache memory, registers and buffers. Data that populates system memory 135 includes computer 101's operating system (OS) 137 and application programs 143.

OS 137 includes a shell 139, for providing transparent user access to resources such as application programs 143. Generally, shell 139 is a program that provides an interpreter and an interface between the user and the operating system. More specifically, shell 139 executes commands that are entered into a command line user interface or from a file. Thus, shell 139, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 141) for processing. Note that while shell 139 is a text-based, line-oriented user interface, the present invention will equally well support other user interface modes, such as graphical, voice, gestural, etc.

As depicted, OS 137 also includes kernel 141, which includes lower levels of functionality for OS 137, including providing essential services required by other parts of OS 137 and application programs 143, including memory management, process and task management, disk management, and mouse and keyboard management.

Application programs 143 include a renderer, shown in exemplary manner as a browser 145. Browser 145 includes program modules and instructions enabling a world wide web (WWW) client (i.e., computer 101) to send and receive network messages to the Internet using hypertext transfer protocol (HTTP) messaging, thus enabling communication with software deploying server 149 and other computer systems.

Application programs 143 in computer 101's system memory (as well as software deploying server 149's system memory) also include a Manufacturing Device Configuration Logic (MDCL) 147. MDCL 147 includes code for implementing the processes described below, including those described in FIGS. 2-8. In one embodiment, computer 101 is able to download MDCL 147 from software deploying server 149, including in an on-demand basis, wherein the code in MDCL 147 is not downloaded until needed for execution. Note further that, in one embodiment of the present invention, software deploying server 149 performs all of the functions associated with the present invention (including execution of MDCL 147), thus freeing computer 102 from having to use its own internal computing resources to execute MDCL 147.

Note that the hardware elements depicted in computer 101 are not intended to be exhaustive, but rather are representative to highlight essential components required by the present invention. For instance, computer 101 may include alternate memory storage devices such as magnetic cassettes, digital versatile disks (DVDs), Bernoulli cartridges, and the like. These and other variations are intended to be within the spirit and scope of the present invention.

With reference now to FIG. 2, an exemplary manufacturing device being configured in accordance with one or more embodiments of the present invention is depicted as robotic manufacturing device 251 (analogous to the robotic manufacturing device 151 shown in FIG. 1). While the robotic manufacturing device 251 is a robotic device, other manufacturing devices, such as a computer numerical control (CNC) device, that are configurable under the control and direction of a computer may also be configured in accordance with the descriptions provided herein. That is, although a robotic manufacturing device is described as being configured according to the inflation expectation value described herein, other manufacturing devices can also be configured accordingly. For example, a CNC device can include a cutter, lathe, mill, router, etc. that are configured by replacing bits, adjusting jigs, reprogramming cutting and other operations, etc. based on the inflation expectation value described herein.

As shown in FIG. 2, robotic manufacturing device 200 is controlled by a central controller 201, which may utilize one or more of the components shown in FIG. 1 for computer 101. As with a CNC device, robotic manufacturing device 251 may include a machining device 202, which is capable of creating various goods by drilling, milling, cutting, turning, etc. feedstock such as metals, wood, plastic, etc. that are selectively supplied to the robotic manufacturing device 251 via a feedstock supply mechanism 204. For example, feedstock supply mechanism 204 may provide steel from a roll, wood from a conveyor belt, fasteners and other supplies from a rail channel, etc. that are needed to construct a good (i.e., a physical product). If the robotic manufacturing device 251 utilizes a molding device 206 (e.g., an injection molding device for creating plastic objects in a heated mold), the feedstock supply mechanism 204 may include a pipeline/tank that provides plastic pellets to the molding device 206 for melting/molding into a desired good or component of the desired good.

In an embodiment of the present invention, robotic manufacturing device 251 also includes a robotic arm mechanism 208, which is a physical mechanism that is capable of grasping and maneuvering components of a product/good for assembly.

In an embodiment of the present invention, robotic manufacturing device 251 also includes a testing device 210, which tests the good being created by robotic manufacturing device 251, either upon completion or during intermediate assembly/manufacturing steps. For example, testing device 210 may be an electrical tester that uses electrical probes/signal generators to test a particular electronic circuit in the good being manufactured for that electronic circuit's functionality, power supply, continuity, insulation, etc. Similarly, testing device 210 may be a manipulator that tests a particular component of the good for its range of motion, strength in movement, etc.

In an embodiment of the present invention, product position sensors 212 detect to position of the product/good being manufactured relative to the robotic manufacturing device 251, thus allowing the testing device 210, robotic arm mechanism 208, machining device 202, etc. to be positioned where needed to perform their manufacturing/testing functions. Examples of product position sensors 212 include, but are not limited to, cameras, electromagnetic energy transceivers that measure echo/reflection times, etc. that detect the position/presence of objects used in the assembly of the good/product being manufactured by the robotic manufacturing device 251.

In one or more embodiments, robotic manufacturing device 251 is capable of locomotion (self movement) using a locomotion mechanism 214, which may be a motorized track crawler, motorized wheels, etc. capable of moving the robotic manufacturing device 251 to different stations on an assembly line. The locomotion mechanism 214 maneuvers according to signals generated by locomotion sensors 216, which may be cameras that detect various obstacles, etc., or sensors that detect signals from a laid electronic line (e.g., a wire embedded in the floor of a factory) that direct the movement of the robotic manufacturing device 251 using the locomotion mechanism 214.

In one or more embodiments of the present invention, robotic manufacturing device 251 is configured by component positioning device(s) 218, which are electronically controlled mechanical devices that maneuver, position, and otherwise set up and configure the equipment depicted in FIG. 2 within the robotic manufacturing device 251. For example, one of the component positioning device(s) 218 may be a robotic arm that configures robotic arm mechanism 208, machining device 202, feedstock supply mechanism 204, etc. This robotic arm physically maneuvers, repositions, and otherwise adjusts the physical configuration of the physical components used by the robotic manufacturing device 251.

The present invention configures the robotic manufacturing device 251 according to consumers' expectations of inflations. That is, if consumers expect inflation to rise, then the robotic manufacturing device 251 is configured to increase production, thereby driving prices down (at least for products produced by robotic manufacturing device 251). If consumers expect inflation to go down (or even deflation to occur), then the robotic manufacturing device 251 is configured to decrease production, thereby putting pressure on prices to rise (inflation to go up).

Thus, if consumers expect inflation to rise and start purchasing products pre-emptively while prices are relatively low, the robotic manufacturing device 251 will likewise pre-emptively increase production. This leads to an improvement of the functionality of the robotic manufacturing device 251, since the robotic manufacturing device 251 will not be overworked in the future, which would lead to downtime for repairs, delays in obtaining needed supplies and/or feedstock, etc.

Alternatively, if the inflation expectation factor reflects consumers' expectation that there will be a decrease in inflation, then consumers will not feel pressured to make purchases at the present time. This leads to the robotic manufacturing device 251 cutting back production at the present time, thereby allowing the robotic manufacturing device 251 to undergo elective maintenance procedures, stockpile feedstock, etc., such that the robotic manufacturing device 251 is in condition to produce more goods in the future (thus improving the functionality of the robotic manufacturing device 251).

The present invention uses an inflation expectation, rather than a measure of actual inflation, to configure the robotic manufacturing device 251. The commonly used measure of inflation is either Consumer Price Index (CPI) or Core CPI (for long run inflation). The CPI is a statistical estimate of inflation based on certain predefined goods and/or services that have been deemed to be representative of overall pricing for all goods and/or services. A similar inflation index is the price index for Personal Consumption Expenditures (PCE), which is often viewed as a more dynamic index. However, both the CPI and PCE do not predict inflation, but rather identify what the current rate of inflation is.

Thus, the present invention utilizes a novel modification to a noise tolerant time-varying (NTT) algorithm to test out different products/bundles used to generate a variety of values for a given index (i.e., an inflation expectation index, also referred to herein as an inflation expectation prediction model). The products/bundles that are the best at predicting inflation according to the modified NTT algorithm are used to optimize an inflation expectation prediction model, as used by an inflation expectation monitor (IEM). That is, the present invention does not merely predict inflation rates (an objective value), but rather consumer expectations for inflation (a subjective value).

The Inflation Expectation Monitor (IEM) integrates artificial intelligence (AI) agent technology, which monitors, continuously learns about, and tracks user shopping behavior and intent over time, together with information that is mined from Web registries, news feeds and real-time transaction logs to estimate an inflation expectation index. The Cognitive Component of this invention relates these behaviors to other seemingly unrelated activities of users of the system in order to first correlate, then corroborate, and finally originate Inflation Expectation predictions.

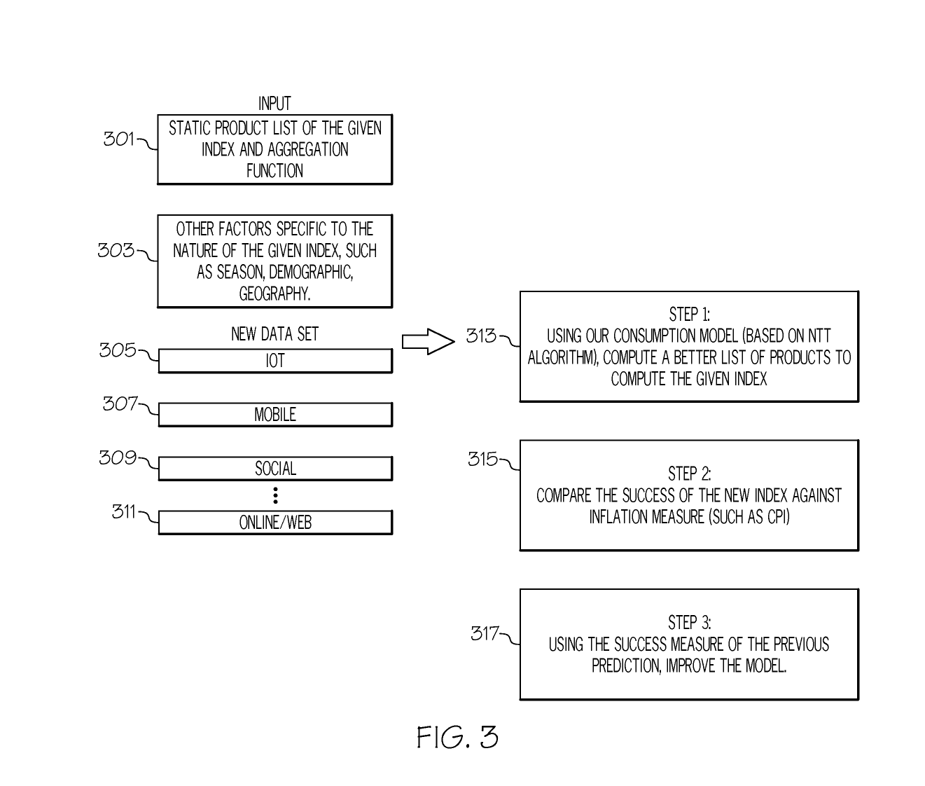

With reference now to FIG. 3, an overview of the process used to compute an inflation expectation value (IEV) in accordance with one or more embodiments of the present invention is presented. The inflation expectation value (IEV) describes an expected rise of fall in an inflation descriptor, such as the CPI or PCE described above. For example, if the CPI is expected to go up 5% based on the processes described herein, then the IEV would be +5%. Similarly, if the CPI is expected to go down based on the processes described herein, then the IEV would be −5%.

As shown in FIG. 3, the initial inputs to the process used to generate the IEV begin with a static product list for a particular index (e.g., durable goods index) as aggregated according to the index (see block 301). These factors lead to an initial inflation expectation index (IIEI). The IIEI is then adjusted for seasons, demographics, geographic regions, etc., as depicted in block 303.

The present invention then provides additional data from sensors and data mining to adjust the IIEI in order to create the IEV of the present invention. Such data comes from an Internet of Things (IOT)—see block 305; mobile devices—see block 307; social networks—see block 309; and online/web pages—see block 311.

The IOT described in block 305 is a network of devices that are able to communicate among themselves, thus providing a description of activities associated with the IOT. For example, assume that the IOT is a group of point of sale (POS) terminals in a retail store. The POS terminals are thus able to communicate with one another, thereby sharing retail sales data. In another example, the IOT may be a group of durable goods, such as automobiles, refrigerators, petrochemical pumps, etc. Each of these durable goods has one or more sensors, which describe the current operational state of the durable good to which they are attached. For example, each pump in a petrochemical plant may have a sensor that detects vibration on the pump, heat generated by the pump, the number of hours that the pump has run, etc. This information is communicated with the other sensor-enabled pumps, thus, leading to an overall understanding of the state of all of the pumps, when they will need to be replaced, etc.

Mobile devices depicted in block 307 may include smart phones (i.e., cellular phones that are able to communicate with the Internet or other networks). These mobile devices are able to generate information related to where the user is located, where the user is shopping, what activities the user is engaged in, etc. using a positioning system (e.g., a global positioning system—GPS) that produces a history of where the user has been (assuming that the user has expressly authorized this monitoring). Based on readings from the mobile devices, an overall picture of activities of multiple users can be created. That is, if the mobile devices report that the users are each spending several hours a day driving his/her vehicle, then a conclusion is reached that the vehicles are being heavily utilized, and will need to be replaced sooner than later.

The social networks depicted in block 309 can be data mined to identify a sentiment of the users/consumers from social media pages. For example, if a high incidence of statements indicating that members of the social networks expect inflation to go up (e.g., according to certain key words or phrases such as “expect” and “increased inflation”) will impact the value generated for the IEV. Similarly, web pages, blogs, etc. found on the Internet (see block 311) can also be data mined for sentiment words (e.g., “expect” and “increased inflation”), thus leading to an adjustment of the IEV.

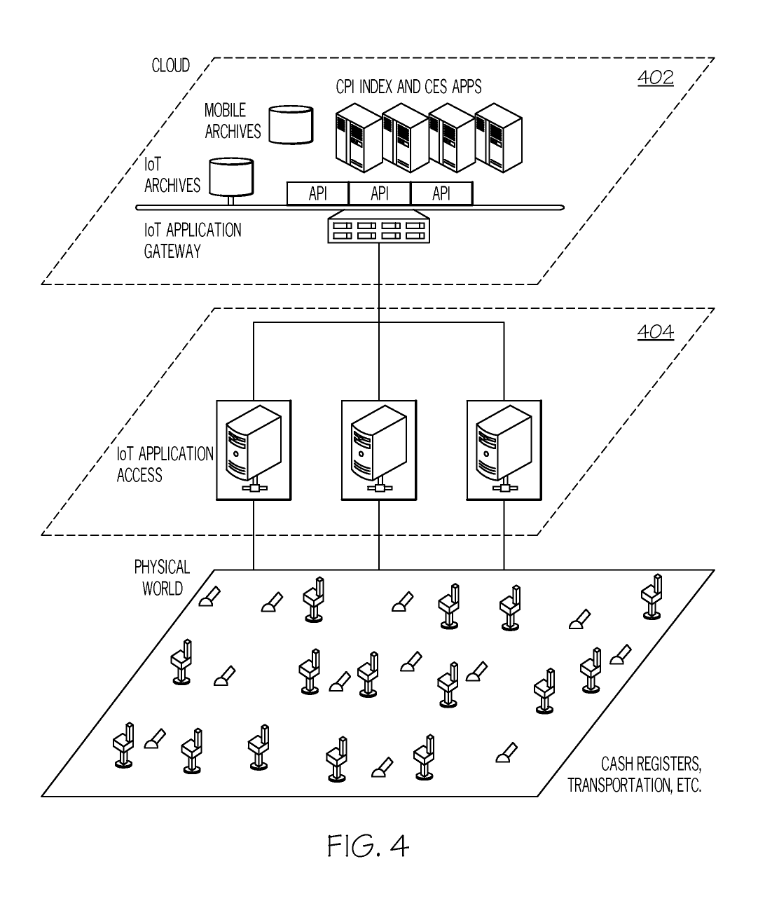

Thus, as shown in FIG. 4, a cloud 402 of resources produces inputs described in blocks 301-311 in FIG. 3. As depicted in block 404 in FIG. 4, the physical devices that produce such inputs are from the physical world, including the Internet of Things, cash registers, vehicles, etc.

The present invention utilizes a Noise Tolerant Time-varying (NTT) algorithm. A NTT algorithm simultaneously models/factors related activities, user attributes, user histories, etc. in order to predict future actions. Exemplary NTT algorithms include an Action bias NTT, an influence factor NTT, a correlation factor NTT, and a Joint probability NTT. One or more of the NTT algorithms use as inputs factors including, but not limited to, levels of consumption by a particular set of consumers; purchasing histories of the particular set of consumers; groupings of consumers; biases in the system; and correlations between user's actions and the rate of inflation. This leads to an output of the set of predicted consumption actions, or more specifically, what products will apply pressure to an inflation index such as the CPI. That is, the inputs adjust which factors are used to generate an inflation index (e.g., a CPI) as well as the inflation expectation value (IEV).

In one or more embodiments of the present invention, the consumption of particular sets of goods, which leads to the CPI as well as the IEV, utilizes a Constant Elasticity of Substitution (CES) algorithm, such as:

$$C = {[ {\sum }_{i = 1}^{n} {a}_{i}^{\frac{1}{s}} {c}_{i}^{\frac{( s - 1 )}{s}} ]}^{\frac{s}{( s - 1 )}}$$

In this equation, C is an aggregate consumption of the set of goods. The variables aᵢ are shared parameters among the set of goods, and s is the elasticity of substitution. The elasticity of substitution is a ratio of two inputs to a function that define the level of variance that is invoked by a substitution. That is, the elasticity of substitution identifies the substitutability between goods used to define the CPI and/or IEV. Thus, each of the consumption goods Cᵢ are perfect substitutes when s approaches infinity and perfect complements (inverse substitutes) when s approaches zero.

Returning now to FIG. 3, as shown in Step 1 in block 313, the NTT algorithms, using the inputs described above, modify the initial IEV by identifying a better list of products used to compute the inflation index (initial IEV). For example, assume that the CPI index initially used the price of refrigerators in its calculations. However, the NTT algorithms using the inputs described above show that the price of washing machines is a better indicator of the current rate of inflation. As such, the price of washing machines is used to modify not only how the CPI is calculated, but also is used to modify the initial IEV, as described in block 313. Note that the price of washing machines or refrigerators is only one factor used to generate the CPI/IEV. Thus, adjusting the IEV to reflect the price of the washing machines or refrigerators does not have a linear affect on the CPI, but rather is just one factor involved. Nonetheless, the present invention assumes that if the IEV is more accurate in predicting future CPI values, then the present invention assumes that the demand for the washing machines or refrigerators will be impacted accordingly.

As shown in Step 2 in block 315 in FIG. 3, the IEV using the price of washing machines instead of refrigerators is then compared to the future CPI index that incorporated the price of washing machines. If the IEV more accurately predicted the future CPI index using the price of washing machines rather than the price of refrigerators, then in Step 3 (block 317) the IEV and CPI remain modified to utilize the price of washing machines instead of refrigerators. However, if using the price of washing machines instead of refrigerators in the IEV actually caused the correlation between the future CPI and the IEV to be worsen (i.e., the newly-modified IEV was not as effective in predicting the future CPI), then the price of the refrigerators will be used again in future CPI/IEV algorithms.

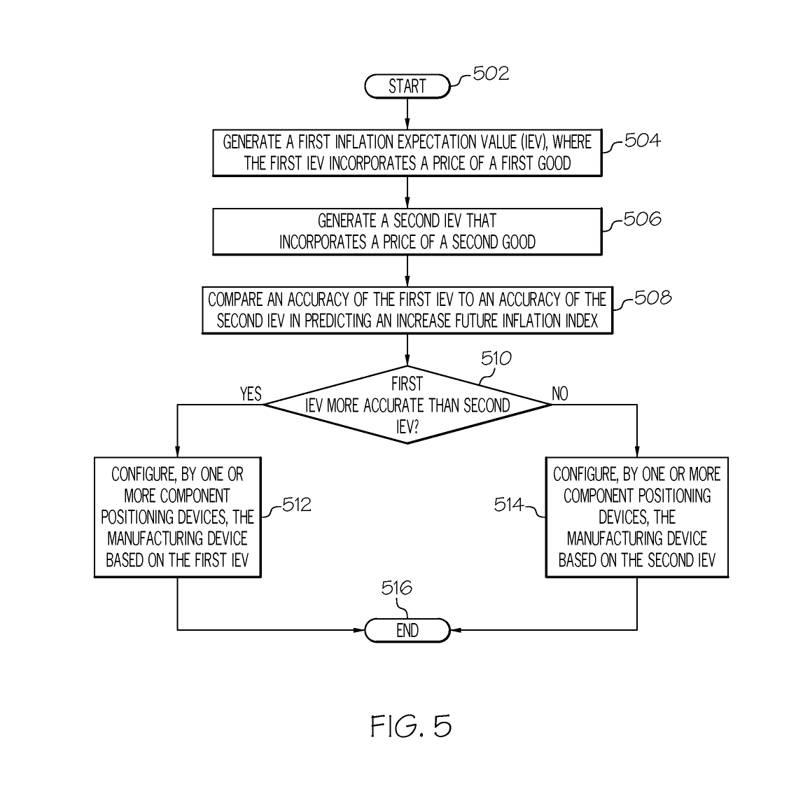

With reference now to FIG. 5, a high level flow chart of one or more steps performed by one or more processors and/or other hardware devices to configure a manufacturing device.

After initiator block 502, one or more processors generate a first inflation expectation value (IEV) that incorporates a price of a first good (see block 504), as described above with the use of CES and NTT algorithms.

As described in block 506, the processor(s) also generate a second IEV that incorporates a price of a second good, and then compare an accuracy of the first IEV to an accuracy of the second IEV in predicting a future inflation index (block 508). That is, the first IEV and the second IEV are examined in the future, to determine which one was better at predicting the future rate of inflation.

As described in query block 510, if the first IEV is more accurate, then one or more component positioning devices (e.g., component positioning device(s) 218 in FIG. 2) configure the manufacturing device (e.g., robotic manufacturing device 251) based on the inflation expectation described by the first IEV (block 512). However, if the second IEV is more accurate, then the manufacturing device is configured based on the inflation expectation described by the second IEV (block 514).

The flow chart ends at terminator block 516.

In an embodiment of the present invention, in response to the first IEV predicting an increase in inflation, the one or more component positioning devices configure the manufacturing device to produce an increased quantity of goods.

In an embodiment of the present invention, in response to the first IEV predicting a decrease in inflation, the one or more component positioning devices configure the manufacturing device to produce a decreased quantity of goods.

In an embodiment of the present invention, in response to the first IEV predicting an increase in inflation, a the one or more component positioning devices adjust a feedstock supply mechanism (e.g., feedstock supply mechanism 204 shown in FIG. 2) to provide additional feedstock required to manufacture an increased quantity of goods by the manufacturing device.

In an embodiment of the present invention, the manufacturing device is a robotic manufacturing device (e.g., robotic manufacturing device 251 shown in FIG. 2). In this embodiment, in response to the first IEV predicting an increase in inflation, the one or more component positioning devices adjust a robotic arm mechanism (e.g., robotic arm mechanism 208 shown in FIG. 2) on the robotic manufacturing device to manufacture an increased quantity of goods.

In an embodiment of the present invention in which the manufacturing device is a robotic manufacturing device, in response to the first IEV predicting an increase in inflation, one or more processors configure a testing device (e.g., testing device 210 shown in FIG. 2) associated with the robotic manufacturing device to test an increased quantity goods produced by the robotic manufacturing device.

In an embodiment of the present invention in which the manufacturing device is a robotic manufacturing device that utilizes a molding device (e.g., molding device 206 shown in FIG. 2), in response to the first IEV predicting an increase in inflation, the one or more component positioning devices configure the molding device to produce an increased quantity of goods.

While the present invention has been described thus far as configuring the robotic manufacturing device 251 solely based on the value of the IEV, in one embodiment the robotic manufacturing device 251 is configured to selectively produce different products. That is, in this embodiment the system configures the robotic manufacturing device 251 according to a correlation between a particular product (that is manufactured by the robotic manufacturing device 251) and how that particular product affects an inflation prediction. Thus, if a particular product is deemed to be a reliable and significant factor in predicting a future inflation rate, then the robotic manufacturing device 251 is configured to produce that particular product at varying capacities that correspond to the predicted future inflation rate.

More specifically, a particular product from the multiple products that are produced by robotic manufacturing device 251 is selected as a factor to be used in determining an inflation expectation for consumers. If the resulting inflation expectation factor is greater than a predetermined level, then the robotic manufacturing device 251 is configured to produce that particular product at a level that exceeds other products that the robotic manufacturing device 251 is capable of producing. That is, the higher inflation expectation factor indicates that there will be pressure to purchase this particular product, and thus the robotic manufacturing device 251 preemptively produces more of this particular product, thereby improving the overall functionality of the robotic manufacturing device 251, since there the robotic manufacturing device 251 will not be overworked (trying to meet future expectations), which would lead to downtime for repairs, delays in obtaining needed supplies and/or feedstock, etc.

Alternatively, if the resulting inflation expectation factor (as determined by using the particular product as an input factor) is less than a predetermined level, then the robotic manufacturing device 251 is configured to produce that particular product at a level that is blow that of other products that the robotic manufacturing device 251 is capable of producing. That is, the lower inflation expectation factor indicates that there will be less pressure to purchase this particular product, and thus the robotic manufacturing device 251 preemptively produces less of this particular product and more of the other products that it is capable of producing. Thus, the overall functionality of the robotic manufacturing device 251 is improved, since there the robotic manufacturing device 251 will be properly utilized producing the other products and will not be overworked (trying to meet required pressure for the other products), which would lead to downtime for repairs, delays in obtaining needed supplies and/or feedstock, etc.

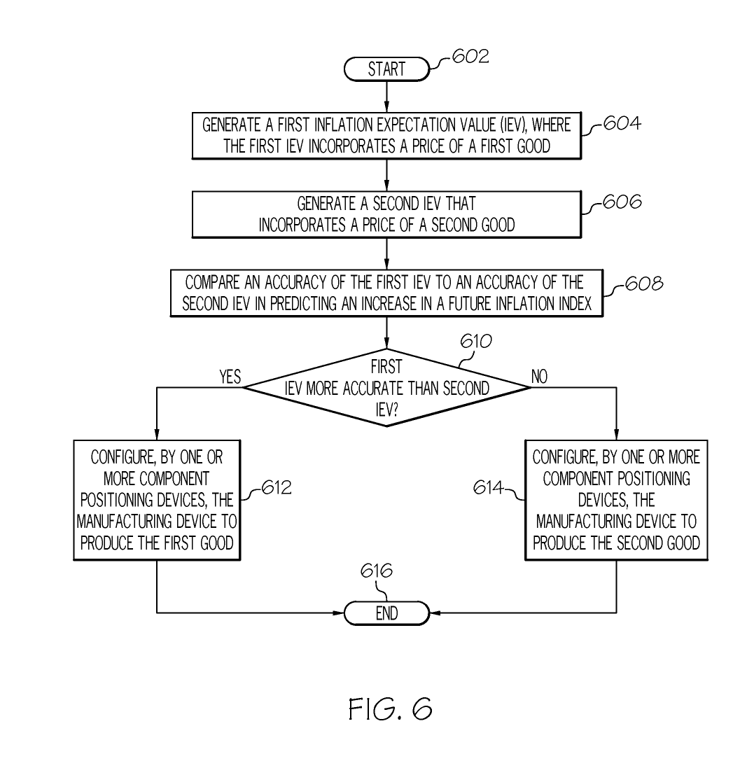

Thus, FIG. 6 is a high level flow chart of one or more steps performed by one or more processors and/or other hardware devices to configure a manufacturing device that is selectively configurable to produce a first good and a second good in accordance with one or more embodiments of the present invention.

After initiator block 602, one or more processors generate a first inflation expectation value (IEV), as described in block 604. The first IEV incorporates a price of the first good. As described above, the present invention utilizes a modified NTT algorithm to track consumption of the first good and to predict patterns in products that will impact a future inflation index, and also incorporates the use of a CES algorithm to identify how substitutable one product is for another, in order to identify which goods should be substituted into the CPI/IEV algorithms.

As described in block 606, the processor(s) also generate a second IEV that incorporates a price of the second good.

As described in block 608, the processor(s) compare an accuracy of the first IEV to an accuracy of the second IEV in predicting an increase in a future inflation index. That is, the first IEV incorporates the first product to predict a future inflation index (e.g., a future CPI value). The second IEV incorporates a second product to predict the future CPI value. As shown in query block 610, a determination is later made to identify which IEV was more accurate in predicting the future CPI value: the first IEV or the second IEV.

As described in block 612, if the first IEV was more accurate, then one or more component positioning devices (e.g., component positioning device(s) 218 shown in FIG. 2) configure the manufacturing device (e.g., robotic manufacturing device 251 shown in FIG. 2) to produce the first good. Otherwise, the component positioning device(s) configure the manufacturing device to produce the second good.

The flow chart ends at terminator block 618.

Thus, the present invention utilizes an inflation prediction, which is based in part on the future price of a particular good. If the price of that particular good is predicted to increase by the IEV, and in fact does so (as confirmed by the future CPI), then 1) this particular good is an accurate factor to be utilized in both the IEV and the CPI, and 2) the manufacturing device(s) that make this particular good is configured before the price actually goes up or down. That is, the IEV correctly predicts that the price of that particular good will go up or down. The manufacturing device that produces this particular good in order to 1) produce the number of units of this particular product needed to meet future demand, 2) push future prices down (by making more of the particular product, thus pushing down the level of inflation), and/or 3) push future prices up (by making fewer of the particular product, thus pushing up the level of inflation in order to avoid deflation).

Thus, in an embodiment of the present invention, in response to the first IEV more accurately predicting the future inflation index than the second IEV, the one or more component positioning devices configure the manufacturing device to produce an increased quantity of the first good.

Similarly, in response to the first IEV more accurately predicting the future inflation index than the second IEV, the one or more component positioning devices configure the manufacturing device to produce the second good at a lesser rate than a rate at which the first good is produced by the manufacturing device.

In an embodiment, the component positioning device(s) 218 shown in FIG. 2 adjust the feedstock supply mechanism 204 in FIG. 2 to enable the manufacturing device (e.g., robotic manufacturing device 251 shown in FIG. 2) to produce the good (physical product) at a level indicated by the IEV. That is, in response to the first IEV more accurately predicting the future inflation index than the second IEV, the one or more component positioning devices adjust a feedstock supply mechanism to provide additional feedstock required to manufacture an increased quantity of the first good (assuming that the use of the first good in the first IEV accurately predicted a rise in inflation). However, if the first IEV predicts deflation as measured by the CPI, then the feedstock supply mechanism is adjusted to provide a lesser quantity of feedstock needed to produce the first good.

Similarly, the robotic arm mechanism 208 shown in FIG. 2 can be adjusted by the component positioning device(s) 218 to enable the robotic manufacturing device 251 to make more or less of the first good utilized in the first IEV. That is, in response to the first IEV more accurately predicting the future inflation index than the second IEV, the one or more component positioning devices adjust a robotic arm mechanism on the robotic manufacturing device to manufacture an increased quantity of the first good by the robotic manufacturing device (if the first IEV predicts an overall rise in product prices) or a decreased quantity of the first good by the robotic manufacturing device (if the first IEV predicts an overall drop in product prices).

Similarly and in an embodiment in which the manufacturing device is a robotic manufacturing device, in response to the first IEV more accurately predicting the future inflation index than the second IEV, one or more processors configure the testing device 210 shown in FIG. 2 to test an increased quantity of the first good produced by the robotic manufacturing device.

Similarly and in an embodiment in which the manufacturing device is a robotic manufacturing device that utilizes a molding device, in response to the first IEV more accurately predicting the future inflation index than the second IEV, the component positioning devices 218 configure/position the molding device 206 shown in FIG. 2 to produce the first good, either at a new rate (assuming that the robotic manufacturing device was not previously making the first good), at a faster rate (assuming that the first IEV is predicting a rise in the price of all goods, including the first good), or at a slower rate (assuming that the first IEV is predicting a fall in the price of all goods, including the first good).

In one or more embodiments, the present invention is implemented in a cloud environment. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

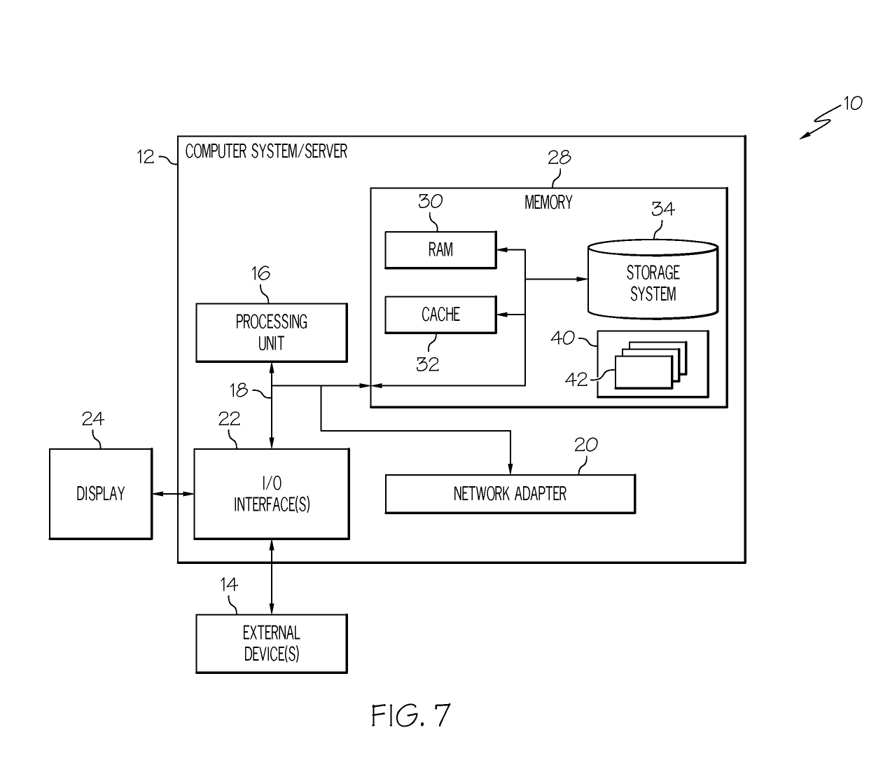

Referring now to FIG. 7, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

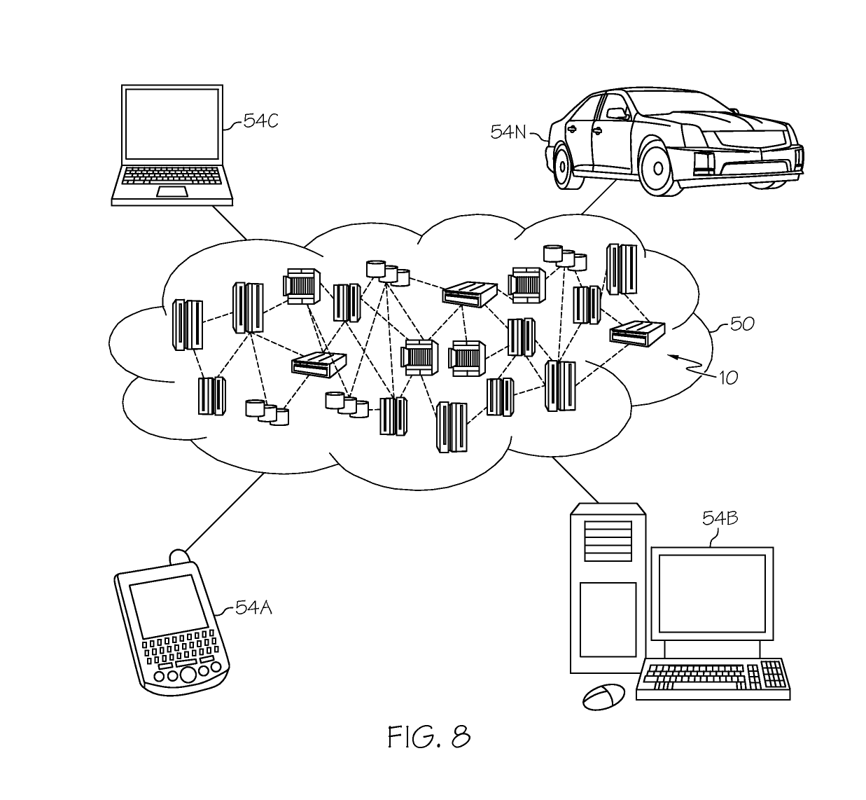

Referring now to FIG. 8, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

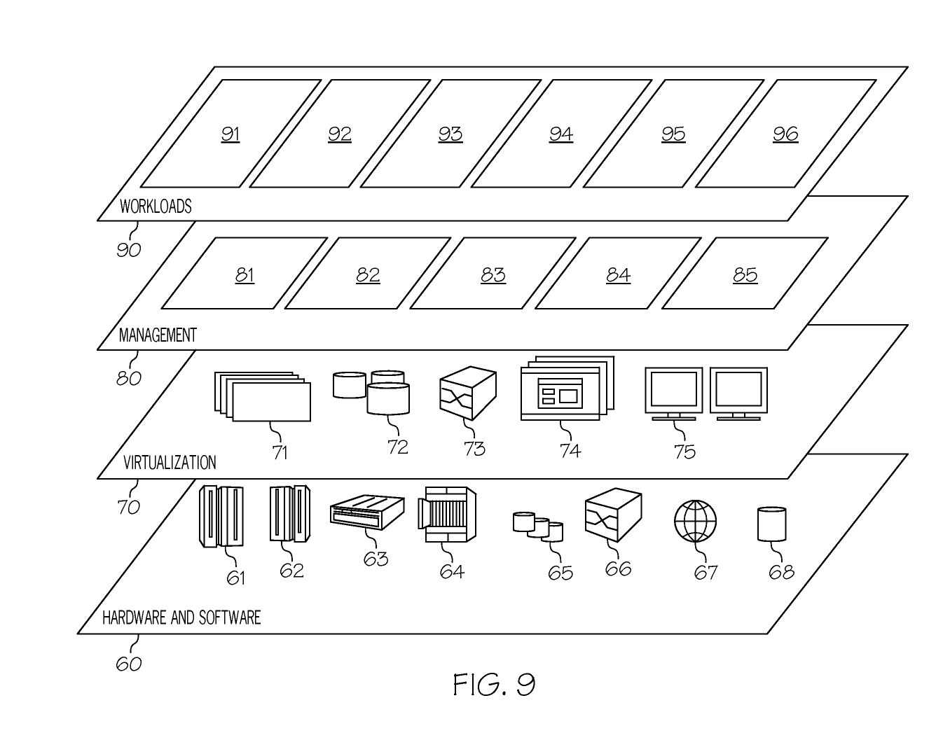

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and manufacturing device configuration processing 96 (for configuring a manufacturing device as described herein).

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the present invention in the form disclosed. Many modifications and variations will be apparent to those of ordinary skill in the art without departing from the scope and spirit of the present invention. The embodiment was chosen and described in order to best explain the principles of the present invention and the practical application, and to enable others of ordinary skill in the art to understand the present invention for various embodiments with various modifications as are suited to the particular use contemplated.

Any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the present invention of the present application in detail and by reference to illustrative embodiments thereof, it will be apparent that modifications and variations are possible without departing from the scope of the present invention defined in the appended claims.

What is claimed is:

1. A method for configuring a manufacturing device, the method comprising:
generating, by one or more processors, a first inflation expectation value (IEV), wherein the first IEV incorporates a price of a first good;
generating, by one or more processors, a second IEV that incorporates a price of a second good;
comparing, by one or more processors, an accuracy of the first IEV to an accuracy of the second IEV in predicting a future inflation index; and
in response to the first IEV more accurately predicting the future inflation index than the second IEV, configuring, by one or more component positioning devices, future configurations of a manufacturing device based on an inflation expectation described by the first IEV.

2. The method of claim 1, further comprising:
in response to the first IEV predicting an increase in inflation, configuring, by the one or more component positioning devices, the manufacturing device to produce an increased quantity of goods.

3. The method of claim 1, further comprising:
in response to the first IEV predicting a decrease in inflation, configuring, by the one or more component positioning devices, the manufacturing device to produce a decreased quantity of goods.

4. The method of claim 1, further comprising:
in response to the first IEV predicting an increase in inflation, adjusting, by the one or more component positioning devices, a feedstock supply mechanism to provide additional feedstock required to manufacture an increased quantity of goods by the manufacturing device.

5. The method of claim 1, wherein the manufacturing device is a robotic manufacturing device, and wherein the method further comprises:
in response to the first IEV predicting an increase in inflation, adjusting, by the one or more component positioning devices, a robotic arm mechanism on the robotic manufacturing device to manufacture an increased quantity of goods.

6. The method of claim 1, wherein the manufacturing device is a robotic manufacturing device, and wherein the method further comprises:
in response to the first IEV predicting an increase in inflation, configuring, by one or more processors, a testing device associated with the robotic manufacturing device to test an increased quantity goods produced by the robotic manufacturing device.

7. The method of claim 1, wherein the manufacturing device is a robotic manufacturing device that utilizes a molding device, and wherein the method further comprises:
in response to the first IEV predicting an increase in inflation, configuring, by the one or more component positioning devices, the molding device to produce an increased quantity of goods.

8. A computer program product for configuring a manufacturing device, the computer program product comprising a non-transitory computer readable storage medium having program code embodied therewith, the program code readable and executable by one or more processors to perform a method comprising:
generating a first inflation expectation value (IEV), wherein the first IEV incorporates a price of a first good;
generating a second IEV that incorporates a price of a second good;
comparing an accuracy of the first IEV to an accuracy of the second IEV in predicting a future inflation index; and
in response to the first IEV more accurately predicting the future inflation index than the second IEV, configuring, by one or more component positioning devices, future configurations of a manufacturing device based on an inflation expectation described by the first IEV.

9. The computer program product of claim 8, wherein the method further comprises:
in response to the first IEV predicting an increase in inflation, configuring, by the one or more component positioning devices, the manufacturing device to produce an increased quantity of goods.

10. The computer program product of claim 8, wherein the method further comprises:
in response to the first IEV predicting a decrease in inflation, configuring, by the one or more component positioning devices, the manufacturing device to produce a decreased quantity of goods.

11. The computer program product of claim 8, wherein the method further comprises:
in response to the first IEV predicting an increase in inflation, adjusting, by the one or more component positioning devices, a feedstock supply mechanism to provide additional feedstock required to manufacture an increased quantity of goods by the manufacturing device.

12. The computer program product of claim 8, wherein the manufacturing device is a robotic manufacturing device, and wherein the method further comprises:
in response to the first IEV predicting an increase in inflation, adjusting, by the one or more component positioning devices, a robotic arm mechanism on the robotic manufacturing device to manufacture an increased quantity of goods.

13. The computer program product of claim 8, wherein the manufacturing device is a robotic manufacturing device, and wherein the method further comprises:
in response to the first IEV predicting an increase in inflation, configuring, by one or more processors, a testing device associated with the robotic manufacturing device to test an increased quantity goods produced by the robotic manufacturing device.

14. The computer program product of claim 8, wherein the manufacturing device is a robotic manufacturing device that utilizes a molding device, and wherein the method further comprises:
in response to the first IEV predicting an increase in inflation, configuring, by the one or more component positioning devices, the molding device to produce an increased quantity of goods.

15. A computer system comprising:
a processor, a computer readable memory, and a non-transitory computer readable storage medium;
first program instructions to generate a first inflation expectation value (IEV), wherein the first IEV incorporates a price of a first good;
second program instructions to generate a second IEV that incorporates a price of the second good;
third program instructions to compare an accuracy of the first IEV to an accuracy of the second IEV in predicting a future inflation index; and
fourth program instructions to, in response to the first IEV more accurately predicting the future inflation index than the second IEV, configure, by one or more component positioning devices, future configurations of a manufacturing device based on an inflation expectation described by the first IEV; and wherein
the first, second, third, and fourth program instructions are stored on the computer readable storage medium and executed by the processor via the computer readable memory.

16. The computer system of claim 15, further comprising:
fifth program instructions to, in response to the first IEV predicting an increase in inflation, configure, by the one or more component positioning devices, the manufacturing device to produce an increased quantity of goods; and wherein
the fifth program instructions are stored on the computer readable storage medium and executed by the processor via the computer readable memory.

17. The computer system of claim 15, further comprising:
fifth program instructions to, in response to the first IEV predicting a decrease in inflation, configure, by the one or more component positioning devices, the manufacturing device to produce a decreased quantity of goods; and wherein
the fifth program instructions are stored on the computer readable storage medium and executed by the processor via the computer readable memory.

18. The computer system of claim 15, further comprising:
fifth program instructions to, in response to the first IEV predicting an increase in inflation, adjust, by the one or more component positioning devices, a feedstock supply mechanism to provide additional feedstock required to manufacture an increased quantity of goods by the manufacturing device; and wherein
the fifth program instructions are stored on the computer readable storage medium and executed by the processor via the computer readable memory.

19. The computer system of claim 15, further comprising:
fifth program instructions to, in response to the first IEV predicting an increase in inflation, adjust, by the one or more component positioning devices, a robotic arm mechanism on the robotic manufacturing device to manufacture an increased quantity of goods; and wherein the fifth program instructions are stored on the computer readable storage medium and executed by the processor via the computer readable memory.

20. The computer system of claim 15, further comprising:
fifth program instructions to, in response to the first IEV predicting an increase in inflation, configure a testing device associated with the robotic manufacturing device to test an increased quantity goods produced by the robotic manufacturing device; and wherein the fifth program instructions are stored on the computer readable storage medium and executed by the processor via the computer readable memory.
